(19) United States
(12) Patent Application Publication
(10) Pub. No.: US 2003/0129968 A1
(43) Pub. Date: Jul. 10, 2003

(54) Deferred telephone answering apparatus

(75) Inventor: Joel Ray Earl, Rochester, MN (US)

Correspondence Address: Gero G. McClellan, Moser, Patterson & Sheridan, L.L.P., 3040 Post Oak Boulevard, Suite 1500, Houston, TX, 77056-6582, US

(73) Assignee: International Business Machines Corporation, Armonk, NY

(21) Appl. No.: 10/040,411

(22) Filed: Jan. 7, 2002

(51) Int. Cl. H04M 11/10

(52) U.S. Cl. 455/412

(57) ABSTRACT

Methods, systems and articles of manufacture for handling an incoming telephone call from a calling telephony device at a receiving telephony device. In one embodiment, a method comprises issuing a pre-recorded stand-by message to the calling telephony device indicating that the telephone call will be answered by a user of the receiving telephony device momentarily.

### BACKGROUND OF THE INVENTION

1. Field of the Invention

The present invention generally relates to telephony. More particularly, the invention relates to handling incoming telephone calls.

2. Description of the Related Art

Mobile telephones offer substantial convenience and benefits to users. In general, mobile telephones have freed users from the need to be stationed near any given fixed location in order to make telephone calls. As such, mobile telephony allows for freedom of mobility. In addition, current technology provides users with conveniences such as call waiting, call forwarding, electronic phone books, voice recognition, and a variety of other functions and features which enhance the functionality of mobile telephony.

Despite the benefits of current mobile telephony technology, situations arise which restrict a user's ability to use mobile telephones safely and efficiently. In particular, answering an incoming telephone call may often present problems for the user. For example, the driver may be predisposed with other activities which make it inconvenient or even dangerous to answer incoming calls. One such situation is while driving a car or operating other heavy machinery. It has been statistically proven that drivers who are using mobile telephones while operating a vehicle are four times more likely to be involved in an accident. In response to these problems, some jurisdictions have restricted the use of mobile telephones in vehicles. Even where answering a call is not dangerous, it may nevertheless be inconvenient. For example, the user may be in a meeting, theater, etc. Answering the call in such environments can be distracting for the recipient of the call as well as for others in the vicinity.

Therefore, there is a need for a method and system for handling incoming telephone calls.

### SUMMARY OF THE INVENTION

The present invention generally provides methods, systems and articles of manufacture for handling an incoming telephone call from a calling telephony device at a receiving telephony device. In one embodiment, a method comprises issuing a pre-recorded stand-by message to the calling telephony device indicating that the telephone call will be answered by a user of the receiving telephony device momentarily.

In another embodiment a computer readable medium contains a program which, when executed on a receiving telephony device, performs the foregoing method.

In still another embodiment, a telephony device comprises a communications facility configured to communicate with a plurality of telephony devices; wherein the communications facility is configured to support communication of at least voice data; and a processor configured to perform an operation for handling an incoming telephone call from a calling telephony device of the plurality of telephony devices. The operation comprises issuing a stand-by message to the calling telephony device indicating that the telephone call will be answered by a user momentarily.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a network environment configured for telecommunications.

FIG. 2 is a schematic representation of a telephony device.

FIG. 3 is a flowchart illustrating the operation of a telephony device.

### DETAILED DESCRIPTION OF THE PREFERRED EMBODIMENTS

The present invention generally provides methods, systems and articles of manufacture for handling an incoming telephone call from a calling telephony device at a receiving telephony device.

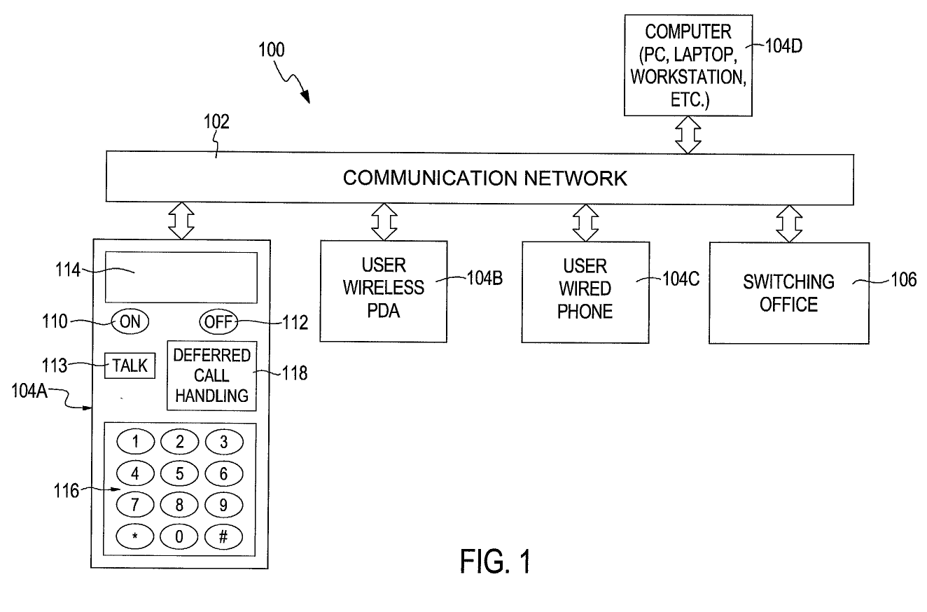

One embodiment of the invention is implemented as a program product for use with a computer system such as, for example, the network environment 100 shown in FIG. 1 and described below. The program(s) of the program product defines functions of the embodiments (including the methods described below) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is an illustrative network environment 100. In general, the network environment 100 includes a communications network 102, a plurality of telephony devices 104A-D (collectively referred to as “telephony devices 104”) and a switching office 106. The communications network 102 may be any system or combination of systems configured to allow communication between the telephony devices 104 themselves, and/or between the telephony devices 104 and the switching office 106. Illustratively, the communications network 102 may be configured for digital cellular (including PCS (personal communications services)), cellular (whether analog or digital), Cellular Digital Packet Data, Global System for Mobile Communication and any other protocol or communications technique. The communications network 102 may also include the public switched telephone network (PSTN), the integrated services digital network (ISDN), the public land mobile radio network (PLMN), etc. In a particular embodiment, the communications network 102 is a public packet data network, such as the Internet. In the present application, the switching office 106 is representative of any system configured to handle communications between the telephony devices via the communications network 102. Although not shown, the network environment 100 may also include known systems and devices such as local exchanges, messaging centers used to provide voicemail services to subscribers, etc.

The telephony devices 104 may be any kind of wireless or wired communication devices capable of establishing a connection with other devices via the communications network 102. Although the telephony devices 104 are shown connected to an apparently singular communications network 102, the communications network 102 may in fact be representative of one or more networks. As such, the telephony devices 104 may each be configured to communicate with the communications network 102 using different communications protocols. In the case where the communications network 102 is the Internet, the telephony devices 104 are enabled with Voice-over-IP (VoIP) telephony.

By way of illustration, the telephony devices shown in FIG. 1 include a wireless telephone 104A, a wireless personal digital assistant 104B (PDA), a land-based wired telephone 104C and a computer 104D. The wireless telephone 104A may include long-range devices such as digital or analog mobile telephones and may also include short-range devices such as wireless telephones for household use. The PDA 104B (also called Personal Communication Device (PCD) and Personal Intelligent Communicator (PIC)) may comprise commercially available PDA devices such as the 3Com Palm, the Casio Casiopeia and the Hewlett Packard Jornada. The PDA 104B may use operating systems such the Palm Pilot™, the Windows CE™ and the Handspring Visor™. The computer 104D represents any other computerized device such as a PC, laptop, workstation, etc., capable of sustaining data communications (and particularly voice communications) with the network 102.

For simplicity, only the details of the wireless telephone 104A are shown. However, it is understood that the illustrated features of the wireless telephone 104A are representative of features included with the other telephony devices 104B-D. In general, the wireless telephone 104A includes an ON button 110, an OFF button 112, a talk button 113, a display screen 114, and a keypad 116. Although each of the buttons are configured for discrete functions, it is understood that any one of the buttons may be overloaded with two or more functions. In the illustrated embodiment, the ON button 110 and OFF button 112 are used to power up and power down, respectively, the wireless telephone 104A. The talk button 113, when pressed, attempts to establish a network connection with another telephony device via the communications network 102. In this respect, the talk button 113 may be used to initiate a telephone call and/or accept an incoming call. The display screen 114 provides a viewing area that may display information to a user. For example, the display screen 114 may display a number dialed, a name of the entity associated with the number (herein referred to as the “callee”), a counter indicating a duration of a call, battery power levels, etc. The keypad 116 is representative of any input interface. In one embodiment, the keypad 116 may be replaced with or work in tandem with, voice recognition technology.

Illustratively, the wireless telephone 104A is also configured with a “deferred call handling” (DCH) button 118. When pressed, the DCH button 118 enables a call handling feature described in more detail below. The DCH button 118 is overloaded to allow both enabling and disabling of DCH. In another embodiment, a separate button may be provided to disable the call handling feature. In a one embodiment, the call handling feature may be an enabled/disabled by manually pressing the button 118. Additionally or alternatively, the call handling feature may be enabled by placing the wireless telephone 104A in a mounting mechanism, such as a hand-free mounting mechanism in an automobile. In such an embodiment, the call handling feature may be disabled by removing the wireless telephone 104A from the mounting mechanism.

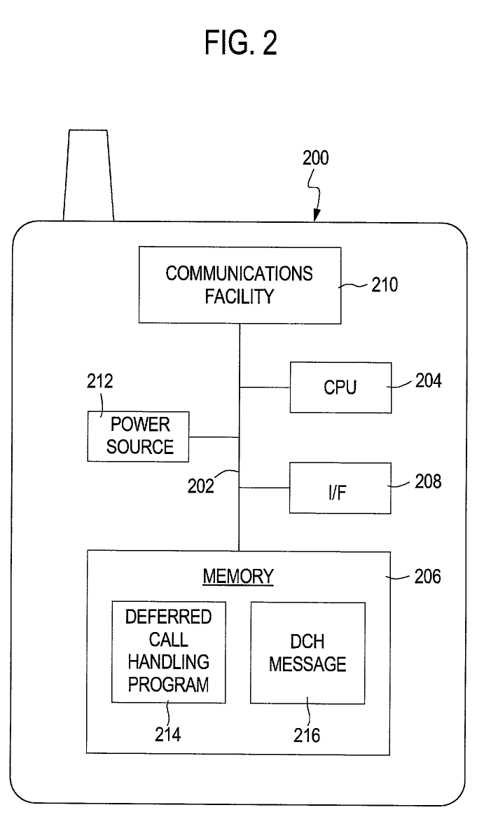

FIG. 2 is an embodiment of a telephony device 200, which is representative of any of the telephony devices 104 shown in FIG. 1. In general, the telephony device 200 includes a bus 202 which connects a processor 204, a memory 206, an input/output device (i.e., an interface) 208, a communications facility 210 and a power source 212. It is understood that the architecture of the telephony device 104 shown in FIG. 2 is merely illustrative and that the devices may be connected differently and, in some cases, not directly connected via the bus 202.

The input/output device 208 is representative of any interface between the bus 202 and another device, such as the buttons 110, 112, 113 and 118, the display screen 114 and the keypad 116 (all shown in FIG. 1). The communications facility 210 is representative of any circuitry configured to support communications between the telephony device 200 and the communications network 102 (shown in FIG. 1). As such, the communications facility 210 may include a transmitter and a receiver, for example. The power source 212 is representative of any power supply capable of energizing the telephony device 200. However, is understood that in other embodiments the power source 212 need not be on board the telephony device 200, such as where a wall power outlet is used.

The processor 204 may be any device capable of implementing the operations and methods described herein. In operation, the processor 204 receives instructions from the memory 206 and performs operations according to the present invention.

The memory 206 may be a random access memory (RAM), read-only memory (ROM), nonvolatile or backup memory (e.g., electronic programmable read only memories (EPROM), flash memories, and the like) or any other memory device capable of holding the necessary data and programming necessary for the operation of the telephony device 200. Illustratively, the memory 206 includes a DCH program 214 and a DCH message 216. When the processor 204 is configured with the DCH program 214 steps are taken to issue the DCH message 216 to a caller indicating that the callee is indisposed and will accept the call shortly. Although the message 216 is shown residing locally on the telephony device 200, persons skilled in the art will recognize that the DCH message 216 may reside remotely, such as at the switching office 106 or at some other messaging center. In the latter embodiment, the DCH program 214, when executed during an incoming call, issues the appropriate instructions to the device or system at which the DCH message 216 resides, whereby the device or system then transmits the message 216 to the caller.

In one embodiment, the DCH program 214 is executed in response to the DCH button 118 (FIG. 1) being pressed during an incoming call. In another embodiment, a user may place the telephony device 200 in a deferred call handling mode by pressing the button 118 whereby subsequently received calls cause the program 214 to issue the DCH message.

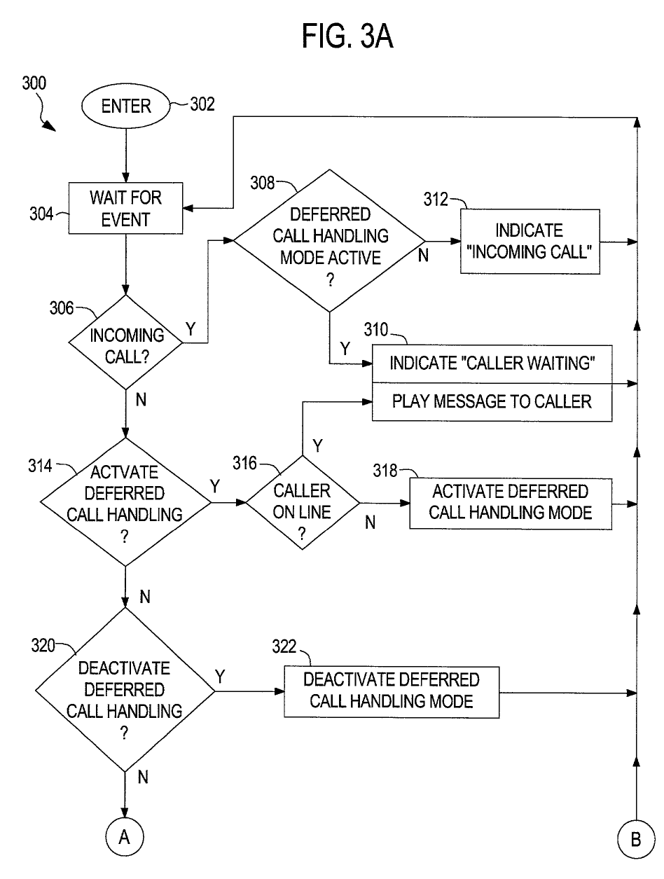

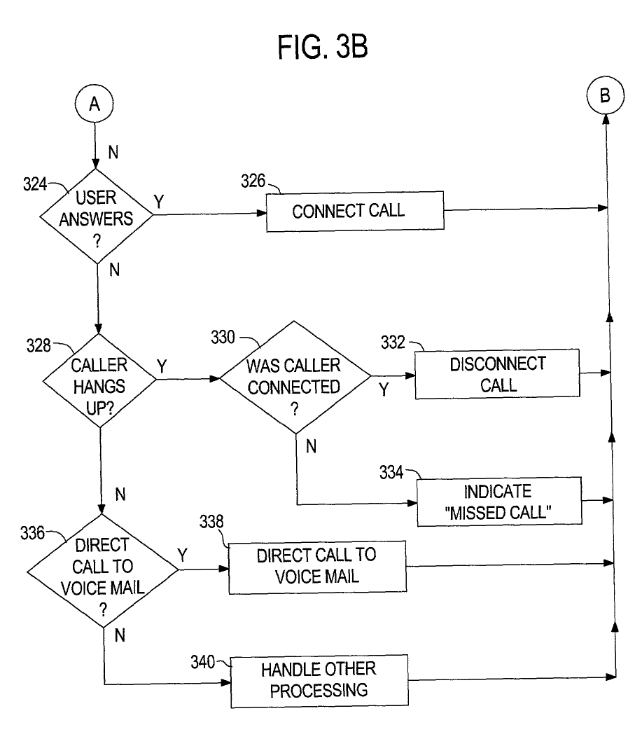

FIG. 3 shows one embodiment of a method 300 for operating the telephony devices 104 and 200. Illustratively, all or part of the method 300 may be considered representative of the execution of the call handling program 214. The method 300 is entered at step 302 and then proceeds to step 304 to wait for an event. When an event is received for handling, processing proceeds to step 306 to query whether the event is an incoming call. If the event is an incoming call, the method 300 proceeds to step 308 to query whether the delayed call handling mode is enabled. As described above, a user may have enabled the call handling mode by manually pressing the DCH button 118, by placing the telephony device in a mounting mechanism or by any of a variety of other means. If the delayed call handling mode is active, then processing proceeds to step 310. In one embodiment, step 310 includes issuing a “caller waiting” signal to the user/callee and issuing the DCH message 216 to the caller. The caller waiting signal may be, for example, an audio signal, a visual signal or a vibrating signal. In one embodiment, the DCH message 216 may include an option message indicating to the caller an option of leaving a voicemail message instead of waiting for the callee to answer the call. If, at step 308, the delayed call handling mode is disabled, then processing proceeds from step 308 to step 312 by signaling an incoming call to the user/callee. In either case, processing then returns to step 304 to wait for the next event.

If step 306 is answered negatively, processing proceeds to step 314 to query whether the event is to activate the delayed call handling mode. Step 314 may be answered affirmatively if, for example, the user has manually pressed the DCH button 118 or placed the telephony device in a mounting mechanism configured to activate the delayed call handling mode. As described above, the delayed call handling mode may be activated prior to receiving a call or during an incoming call. Accordingly, if step 314 is answered affirmatively, the method 300 proceeds to step 316 to query whether a caller is on the line. If so, processing proceeds to step 310, which has been described above. Otherwise processing proceeds to step 318 where the delayed call handling mode is enabled.

If step 314 is answered negatively, the method 300 proceeds to step 320 to query whether the event is to disable the delayed call handling mode. If so, the delayed call handling mode is disabled at step 322. Processing then returns to step 304. If the event is not to disable the delayed call handling mode, processing proceeds from step 320 to step 324.

At step 324 the method queries whether the event is to answer an incoming call. If so, the call is connected at step 326. Processing then returns to step 304.

If step 324 is answered negatively, the method 300 proceeds to step 328 to query whether the caller has hung up. If so, processing proceeds to step 330 to query whether the caller was connected at step 326. If the caller was connected, the call is disconnected at step 332. If the caller was not connected, a “missed call” is logged at step 334. Processing then returns to step 304.

If step 328 is answered negatively, the method 300 proceeds to step 336 to query whether the event is to direct a call into voicemail. If so, the call is directed to voicemail at step 338. In one embodiment, calls are directed to voicemail a threshold amount of time after the message 216 has been issued to the caller at step 310. If step 336 is answered negatively, the event is handled at step 340 according to any other predefined rules. In either case, processing then returns to step 304.

While the foregoing is directed to embodiments of the present invention, other and further embodiments of the invention may be devised without departing from the basic scope thereof, and the scope thereof is determined by the claims that follow.

What is claimed is:

1. A method of handling an incoming telephone call from a calling telephony device at a receiving telephony device, comprising:
issuing a pre-recorded stand-by message to the calling telephony device indicating that the telephone call will be answered momentarily by a user of the receiving telephony device.

2. The method of claim 1, further comprising:
signaling the telephone call at the receiving telephony device.

3. The method of claim 1, further comprising:
issuing an option message to the calling telephony device specifying to a user of the calling telephony device an option of leaving a voicemail message instead of waiting for the telephone call to be answered by the user of the receiving telephony device.

4. The method of claim 1, further comprising, prior to issuing:
determining that the receiving telephony device is in a deferred answer call handling mode.

5. The method of claim 4, wherein the deferred answer call handling mode is activated by at least one of:
a user action with respect to the receiving telephony device in response to being notified of the telephone call; and
a user action with respect to the receiving telephony device prior to being notified of the telephone call.

6. The method of claim 5, wherein the user action with respect to the receiving telephony device in response to being notified of the telephone call comprises pressing a button on the receiving telephony device.

7. The method of claim 5, wherein the user action with respect to the receiving telephony device prior to being notified of the telephone call comprises placing the receiving telephony device in a vehicle-mounted telephone holding unit.

8. A computer readable medium containing a program which, when executed on a receiving telephony device, performs an operation for handling an incoming telephone call from a calling telephony device, the operation comprising:
issuing a pre-recorded stand-by message to the calling telephony device indicating that the telephone call will be answered by a user of the receiving telephony device momentarily.

9. The computer readable medium of claim 8, wherein the pre-recorded stand-by message is located locally on the computer readable medium.

10. The computer readable medium of claim 8, wherein the pre-recorded standby message is located remotely on a messaging device.

11. The computer readable medium of claim 8, the operation further comprising:
issuing an option message to the calling telephony device specifying to a user of the calling telephony device an option of leaving a voicemail message instead of waiting for the telephone call to be answered by the user of the receiving telephony device.

12. The computer readable medium of claim 8, the operation further comprising, prior to issuing:
determining that the receiving telephony device is in a deferred answer call handling mode.

13. The computer readable medium of claim 12, wherein the deferred answer call handling mode is activated by at least one of:
a user action with respect to the receiving telephony device in response to being notified of the telephone call; and
a user action with respect to the receiving telephony device prior to being notified of the telephone call.

14. The computer readable medium of claim 13, wherein the user action with respect to the receiving telephony device in response to being notified of the telephone call comprises pressing a button on the receiving telephony device.

15. The computer readable medium of claim 13, wherein the user action with respect to the receiving telephony device prior to being notified of the telephone call comprises placing the receiving telephony device in a vehicle-mounted telephone holding unit.

16. The computer readable medium of claim 8, the operation further comprising:
signaling the telephone call at the receiving telephony device.

17. The computer readable medium of claim 16, wherein signaling comprises issuing at least one of a visual signal, a tactile signal and an audible signal.

18. A telephony device, comprising:
a communications facility configured to communicate with a plurality of telephony devices; wherein the communications facility is configured to support communication of at least voice data; and
a processor configured to perform an operation for handling an incoming telephone call from a calling telephony device of the plurality of telephony devices, the operation comprising:
issuing a stand-by message to the calling telephony device indicating that the telephone call will be answered by a user momentarily.

19. The telephony device of claim 18, wherein the device is a mobile telephone.

20. The telephony device of claim 18, further comprising a delayed call handling button which, when pressed, configures the processor to perform the operation upon receiving the incoming telephone call.

21. The telephony device of claim 18, further comprising a delayed call handling button which, when pressed during the incoming telephone call, configures the processor to perform the operation.
